(19) United States
(12) Patent Application Publication
(10) Pub. No.: US 2015/0261419 A1
(43) Pub. Date: Sep. 17, 2015

(54) Web-Based Video Navigation, Editing and Augmenting Apparatus, System and Method

(71) Applicant: Harriett T. Flowers, Irving, TX (US)

(72) Inventor: Harriett T. Flowers, Irving, TX (US)

(21) Appl. No.: 14/727,684

(22) Filed: Jun. 1, 2015

Related U.S. Application Data
(63) Continuation of application No. 13/555,797, filed on Jul. 23, 2012.
(60) Provisional application No. 61/511,223, filed on Jul. 25, 2011.

(51) Int. Cl. G06F 3/0484; G06F 3/0482; G06F 17/30

(52) U.S. Cl. CPC G06F 3/04842; G06F 17/30058; G06F 17/30126; G06F 3/0482

(57) ABSTRACT

A web-based system providing a service for on demand editing, navigation, and augmenting of audiovisual files comprising a pinner/navigator which automatically creates a .CXU file of an audiovisual project file uploaded to the service, the .CXU file capturing incidence time offsets for textual objects in the file, the pinner/navigator comprising an editor providing a graphical user interface enabling users to edit the audiovisual project file by modifying textual objects, pinning beginning and ending boundaries for textual objects of interest, and navigating the file by selecting textual objects, the pinner/navigator automatically outputting an edited project file per user edits; a service API wrapper providing an interface for accessing one or more recognition services which automatically generate semantic metadata comprising recognized objects for the uploaded audiovisual file, a semantics calculator operating on the recognized objects using a semantic calculus, a semantics editor, and an audiovisual file encoder/decoder.

This non-provisional patent application claims priority to the applicant's Provisional Patent Application No. 61/511,223 entitled “Web-based video navigation and editing apparatus and method” e-filed on Jul. 25, 2011 which is incorporated herein in its entirety.

### TRADEMARK NOTICE

The word mark Video Post Script™ is a trademark owned by the Applicant and the Applicant reserves rights therein.

### TITLE

Web-Based Video Navigation, Editing, and Augmenting Apparatus, System and Method

### BACKGROUND

The disclosed invention is directed to computer-implemented systems for on demand editing, navigation, and augmenting of pre-existing audiovisual works (also referred to herein as source audiovisual files). Post-production editing of audiovisual works is a laborious, time-consuming, functionally-limited, user-driven process. The applicant has invented a computer-implemented process that facilitates and semi-automates creation of edited videos and including semantically-edited/enhanced videos derived from one or more source audiovisual files. The applicant's invention simplifies and semi-automates the process while adding novel functionalities for outputting new and interesting derivative works (such as for example a Comic Strip or Graphic Novel) based on source (existing) audiovisual works. The term ‘interesting’ refers to aspects (e.g., visual, semantics-related) of a source audiovisual file that the user wishes to manipulate or augment using the disclosed process.

Batch video editor systems are known. Speech-to-text systems and methods are known. Image processing is known (see for example Instagram). Storyboardiog in film-making is known as a roof facilitating production of audiovisual works based on reference to artist-rendered, sequenced two-dimensional images called storyboards that are visual depictions of scripts or screenplays. A methodology for systematically creating comics is disclosed in Scott McCloud's book entitled Making Comics. Frame-to-Image transformation is known (see for example iPhone app called ToonPoint). See for example US Patent Application Publication No. 2009/0048832. However, the applicant is not aware of prior art systems that provide for a web-based, textual transcript-based navigation and editing of an audiovisual work and editing and augmenting of an audiovisual work using the semantics processing tools and all of the features and functionalities as described herein. The applicant is not aware of prior art systems that support on demand, semi-automated storyboarding-in-reverse (going from video frame to two-dimensional image) for pre-existing audiovisual files. The disclosed invention facilitates and speeds up the process for making edited, including semantically-enhanced edited versions of pre-existing audiovisual works.

The word ‘Project’ and ‘Video Project’ are used interchangeably to refer to an activity/user session facilitated by the disclosed invention whose aim is to create and output an edited audiovisual work based on one or more pre-existing audiovisual files. The word Invention is used herein for convenience and refers to the herein disclosed computer-implemented apparatus, system, and method for navigating, editing, and augmenting of pre-existing audiovisual works. The terms ‘Time stamped Textual File and .CXU file are herein used interchangeably. Other terms are as defined below.

### SUMMARY OF THE INVENTION

The disclosed Invention will be described in terms of its features and functionalities. A proposed architecture per a preferred embodiment for practicing the disclosed invention is also disclosed herein.

Editing a video requires separating one or more portions of the video, called clips, from the whole. The intent is sometimes to re-sequence the clips and often the editor's goal is to minimize the time required to view the edited video while preserving the “interesting” portions of the original video. The user editing the video usually wants to communicate some semantic intent embodied in the video. Prior art video editing systems provide two primary mechanisms for the user to identify and select the boundaries between the desired or “Interesting” portions of the video from the excluded or “uninteresting” portions of the source video:
1) the sequence of video frames and/or
2) the native audio sound track associated with the video, often visually aided by the sound frequency wave form diagram of the audio.

The Invention provides for the ability to identify the boundaries (or pins) for the desired (i.e., interesting) portions of the video automatically using a novel input medium, namely a user-editable transcript (the ‘.CXU file (‘Continuous over X’ file) of the source video, potentially obviating the need for the user to choose boundaries by inspecting either the frames or the audio forms of the source video.

The disclosed Invention also gives users machine-expedited tools to make pre-existing audiovisual works more interesting by augmenting them with semantics, including incorporating a new semantics (e.g., incorporating a plot transposition or plot overlay, see below). Thus, the system for practicing the Invention incorporates automatic n-dimensional semantic distillation (or a semantics mapping) of the source video, where semantic distillation comprises the following steps:
1. Identifies and characterizes, via Recognition Processes, the features that are “interesting” in one or more of the video component forms of (a) visual content (sequential frames), (b) the audio sounds, and (c) the semantic content (meaning) of the transcripts,
2. Captures the elapsed time offsets per the source video for the interesting features (i.e., “where” they are located in the source video), and
3. Filters and ranks potential type and level of interest for the video component forms according to runtime parameters (user-chosen or defaulted).

For illustration, sample default or user-input runtime parameters may be the following: (a) finished video duration, (b) style, (c) recognized object, or (d) plot overlay. Runtime parameters for the degree or level of desired distillation (user-chosen or delimited) determine the total number (as few as one, as many as the entire original video) of frames that can be included in the final selection of clips to be included in the system-generated semantic distillation. The number of frames also indirectly determines the degree of semantic summarization required to best capture any verbal content that may be associated with the selected frames. Runtime parameters (user-chosen or defaulted) determine the form(s) of the system-generated output (listed in order of degree of semantic distillation): (1) an edited video of the desired length, (2) one or more still images (optionally annotated by system-derived text and/or stylized), or (3) a single composite image, a glyph, or icon to potentially be recognized as a visual symbol for the video.

The degree or level of Semantic Distillation may be interpreted to mean the amount of meaning desired to be conveyed by the video versus the time required to watch the video. Thus semantic distillation can be viewed also as a process for enabling a more efficient review of the subject matter and semantic content of a source audiovisual file. So, as illustration of degrees of semantic distillation, the existing art of movie editing includes the following forms, listed in order from undistilled to highly distilled: (1) Raw rootage, (2) Director's cut, (3) Commercial release, (4) Censored Version, (5) Abridged version (e.g., to fit TV time slot):: (6) Trailer; (7) Movie reviews (with spoiler alert), (8) IMDb.com listing, (9) Movie Poster; (10) Movie Title, (11) Thumbnail image, (12) Genre classification (i.e. “Chick Flick”). The Inventions feature of a plot overlay, accomplished via a Plot Actuator (see below), in effect allows users to ‘re-purpose’ pre-existing audiovisual content, and/or automatically introduce a type of “B-roll” or new content to support a desired message based on pre-existing footage. With the disclosed Comics Actuator, the user similarly can semantically distill in degrees, and because the output medium is still images augmented with textual or word bubbles, reviewing the output enabled by the Comics Actuator is potentially much faster than viewing the source video. The degree or level of semantic distillation with the Comics Actuator may for example be in the form of the following outputs (1) Graphic Novel, (2) Weekly Comic (20-24 pp with around 9 frames per page), (3) Sunday ½ page Comic (around 7 frames), (4) Daily Comic strip (3-4 frames), or (5) Captioned Single frame.

The visual representation of the frames and their arrangement relative to each other may be true to the original form of the visual frames or they may be modified by the system according to user-specified (or default) Style parameters. The images may optionally be stylized (see for example http://toonpaint.toon-fx.com), distorted to create caricatures, and/or systematically mapped to alternative forms. One example of a stylization is a Sunday Comic Strip Style. To accomplish this Style, the system would do the following: (1) Limit the total number of frames to three or four images, (2) Use image processing to simplify the shapes in the images and potentially zoom in tor facial close-ups, (3) Simulate old technology newspaper print by rendering all shapes as micro-dots instead of a solid color, (4) Capture the video timing locations for the selected frames, and (5) Summarize all verbiage in each of the frames to fit the comic styled word “balloon” or bubble.

The disclosed Invention also incorporates video plots (‘Plots’ or “Plot Overlays’) in a machine form so they can be used as runtime parameters (user defined or defaulted) to the system for performing the following; (1) identification and classification of what is interesting, (2) template for arranging clips for output, (3) criteria for video classification within a genre, (4) context for semantic comparisons between content from different videos, and (5) additional semantic content to augment the video content.

Several embodiments of the disclosed Invention are disclosed herein. Per a first embodiment, the Invention incorporates a construct that is time stamped textual file (also herein referred to as a .CXU file) and provides for text object-based editing of a source audiovisual file wherein a user edits textual objects per a .CXU file which automatically synchronously operates on the corresponding video and audio content timestamp-linked to the text objects. Per a second embodiment, the Invention includes the above functionality and adds automated image processing which incorporates semantic distillation (as described below) and thus provides for richer editing of pre-existing audiovisual content.

It is noted that the ASCII space character in text objects of the textual transcript can be replaced with a binary number representing the number of seconds from the beginning of the original media where that occurrence of the word is found. A 32 bit “long integer” provides about 120 years in seconds. A normal ASCII character is 8 bits. Thus the Pinner/Navigator provides for two (2) versions of a text document, namely the internal representation with the integer inserted between each word, and the normal, editable version. This pinned text track feature is one reason that the Invention comprises a file decoder as described.

The disclosed graphic user interface (UI) per the Pinner/Navigator preferably comprises, in a grid view (1) a Video Frame Viewer, (2) a Storyboard comprising a listing/display of dynamically created audiovisual frames based on a user's selection (e.g., point-and-click or drag-and-drop) of textual portions (blocks) per a textual transcript, and (3) a textual transcript (Transcript), the Video Frame Viewer, the Storyboard, and the Transcript operatively communicating such that operation on the Transcript automatically and synchronously adjusts the corresponding Storyboard (video frames, waveforms) and Video Frame.

Per a feature of the text editor that operates on the .CXU file, the timestamp associated with a text is displayed automatically when a user points to or selects the text. Per an optional, keystroke-saving feature of the disclosed UI, there is a ‘transitions selection prompt’ whereby a user is prompted to select the type of visual and/or auditory transition to be automatically implemented in the edited video during play of the ‘deselected blocks’(i.e., the breaks in the textual transcript that are the textual blocks cut out by the user during editing/navigation). The UI further comprises an indication (color, highlight, or via other means) of the type of navigation that is presently active, whether normal (pinned text blocks) or n-dimensional semantics-type navigation.

The following are some features and functionalities highlights of the Invention that are not known to the Applicant to be in prior art systems for editing, navigation, and augmenting of pre-existing audiovisual works:
(1) Providing a visual graphic user interface comprising multiple distinct and separate media associated with any one audiovisual work. Including for example 1) an original textual transcript, 2) audio-only file and waveform 3) video frames, and 4) (optional) edited textual transcript, each medium having its own visually recognizable relationship to “time” (transcripts by sequential text characters, audio file by continuous audible sound and sound waveforms, video by frame), and maintaining an accurate relationship in terms of time offsets between and among the media. Thus each of the media is independent and synchronous. The transcript is in a format called .CXU (meaning ‘continuous over X”) whereby the temporal location (in the waveform file) for the recognition of a textual character (or phoneme or granularity) is automatically retained. The .CXU file may be likened to a time-stamped text file. The optional edited transcript medium view includes time lines relative to both the original transcript and to the edited transcript.
(2) Providing a graphical (visual) user interface (‘UI’) having a functionality whereby a user may on demand specify any number of time offsets within the original transcript by “pinning” a textual, character position in the transcript to a point in either the audio waveform view or the video frame view; capturing the time offset associated with the audio or video medium as an attribute of that textual character as well as an indicator that the “pin” was generated by manual selection. Per another functionality of the UL a user may add to or correct the transcript directly from within the user interface.) Thus, a user may ‘edit’ the audiovisual work manually (‘on the fly’) by operating on the transcript. The UI further comprises a navigation functionality for each of the four media such that ‘cursor’ positioning to any sequential location in a medium automatically positions the ‘cursor’ in each of the other three media to the same time offset relative to the original audio and video timings. The navigation may be controlled manually by a point-and-select (click) action by the riser or automatically by a player functionality which automatically traverses the media by encountering start/end pin ‘pairs’ (a set of start/end pins is herein also referred to as a block) in the edited transcript. The “play” functionality of the navigation automatically animates all of the active media views at the same rate of speed (while simultaneously ‘playing’ the audio sound associated with the audio-only medium (i.e., if played at or near standard time—not too fast or slow), beginning at the location indicated by the navigation interface, maintaining the synchronization of the time offsets across all media as it plays. If the navigation is driven by the edited transcript, where the edited transcript comprises selected blocks (start/end pins) and ‘deselected blocks’, the UI prompts the user to select from among options for visual (i.e. seconds-to-black screen, fade in/out, etc.) and aural (sound fade in/out) transition from one selected block to the next selected block. The UI further comprises an n-dimensional semantics navigation whereby the user may optionally identify a set of start/end pins (blocks) of the transcript by the meaning of its content. So, for example, an n-dimensional navigation of the transcript may allow a user to pin a block based on the action depleted in the video frame, the person or group depleted or speaking in the video, a graphic image depicted on the widow, language spoken, or some other useful descriptor of the content underlying the selected pinned set or block. Another attribute of the pins is that they are linkable to a higher order storyboard (i.e., non-contiguous blocks, i.e., blocks pet another distinct audiovisual files).
(3) The original transcript per Item 1 above may optionally be generated by an external source, such as but not limited to an SRT file (subtitle file) or an automated voice recognition software. In that case, the disclosed apparatus automatically accepts the timing offset relationship information generated by such external source, capturing the information as “pins” associated with the textual character, phoneme or word granularity. The pin thus generated shall have as an attribute an indication that its source is an external source (as contrasted with a manual input source described in item 2 above).
(4) Providing an extrapolation algorithm to calculate relative offset within the original transcript (and edited transcript, if available) based on previously captured, proximal “pinned” offsets. The algorithm will differentially weight the reliability of different sources of timing offset pins—in priority order as follows: First priority for manual sourced pinned offsets, second priority for externally-generated pinned offsets information, and last priority for offsets generated via an extrapolation algorithm. The pin estimation algorithm gets progressively better (more accurate) the more the user works with the disclosed apparatus to edit an audiovisual work. The algorithm may for example apply rules such as rate of speed assumptions.
(5) Providing a text editor compatible with the .CXU file which comprises instructions executing an automated analysis of an edited copy of the transcript to associate each character in the edited transcript with its original position in the original, unedited transcript. The analysis may be accomplished either with simple match-merge technology or by deciphering “red-line” markups generated by the text editor. Changes to the edited transcript that represent not simply the selection or re-sequencing of blocks of text, but modification of the textual content itself are identified and may be optionally be applied to the original transcript. If such modification to the textual content is made, the extrapolation algorithm automatically assigns any pins in the original transcript to an estimated new location within the changes.
(6) Providing an automated process generating and capturing a pair of time offset “Pins” in the original transcript representing the start and end locations of each block of text identified as a discontinuity by the edited transcript. The original “Pin” values will also be captured as attributes of the first and last characters of the discontinuous text block in the edited text as well as an indicator that they represent a start and end, respectively. Any other Pins and their attributes in the original transcript are applied to the matching text in the edited transcript.
(7) Providing for automatic capture of user-generated navigation/edit instructions (the timings of cuts and sequencing relative to the original audiovisual work) as an ‘editing/navigation specification’, the editing specification exportable to an external batch video editor.
(8) Providing for batch export of an edited audio/visual codex file that replicates the edited-transcript-driven navigation/play experience, playable externally to the device.
(9) Providing for an optional batch export of the edited transcript as if it were the original transcript of an edited version of the audiovisual work, with all relevant pins adjusted to the edited sequences and timings.
(10) Providing a so-called n-dimensional semantics. Thus, per such feature, in addition to the two textual transcripts (tracks), namely the “natural” transcription associated with the original audiovisual work, and 2) the marked up transcript representing the desired, edited audiovisual output, there may exist any number of action semantic “tracks” or .CXU file entries that may potentially overlap in their timings. The user may use the n-dimensional semantics feature to correctly pin two people talking over each other in the audiovisual work—each person could have his/her own, independent script pins. Alternatively and by way of example, a user may “tag” particular yoga pose or a series of poses, with the capability to Pin it to start and end times. Thus, each pin may have several attributes (source-type (manual, automatic), semantic-type (person, action, topic), ontology-link (if applicable), unique audiovisual file-linked, unique timestamp, boundaries (beginning and ending timing offsets), the block boundary pair defining the source content identified as a Recognized Object, see below. The purpose of the attribute of pin source-type is so that manual-sourced pins are generally given priority over automated sourced pins because manual-sourced pins are deemed to be more accurate recognition and closer to the user-desired recognition.
(11) Providing an additional attribute for pins, namely an ontology reference. It is possible to generalize the “pinning” process across any number of media, each mapped to any mathematical formula. The preferred embodiment of the disclosed apparatus synchronizes the media along a linear time line. However, it is possible to synchronize by an ontology. So, for example, if a book and a video transcript were both correlated to a visual ontology, per an alternative embodiment of the disclosed apparatus, a user could navigate the book by the video, or the video by the ontology itself. In such an application, the additional pin attribute would be an ontology reference.
(12) Providing users the ability to on demand ‘distill’ an audiovisual work to the point of an output comprising a series of one or more static images meeting specified runtime parameters or inputs, with a Sunday Comics Strip format being one possible embodiment of this capability.
(13) Providing users the ability to on demand make pre-existing audiovisual works more interesting by augmenting them with semantics, such as the plot overlay.

### Architecture for the Preferred Embodiment of the Invention

The invention is preferably practiced as a web-based, cloud-enabled architecture comprising the following elements and their associated user interfaces, as applicable:
Projects Controller
Audiovisual File Encoder/Decoder
API Wrapper
Pinner/Navigator
Semantic Calculator
Video PS Semantics Editor
Comics Actuator
Plot Actuator

Also included in the Invention are several Data Stores comprising content and configurations to support all of the described machine processes as follows:
Recognized Objects Data Store
.CXU (Continuous Across X) Text Files
Comics Structures & Temp Sates
Plot Structures & Templates
Semantic Equivalence Relationships
Individual User Ontology Store

It will be apparent to one of ordinary skill in the relevant art that many other types of data stores may also be employed in practicing the Invention.

### Projects Controller

The disclosed Invention is processing-intensive. One of the requirements for the user experience is that the system is highly responsive and engaging. While a one-hour video may take hours of processing time to complete all appropriate analyses as required to practice the Invention, some portions can be at least partially complete in seconds. The projects controller determines what initial processing capabilities are “open” to the user as portions of processing results become available. So, the projects controller does cloud-enabled multi-processor asynchronous processing to accomplish steps comprising:
Managing user and process security
Allocating processing environment (virtual or physical machines) or processing threads
Initiating each of the subsystems, above, as required to accomplish Project requests
Intercepting and detecting exception events (unexpected termination or foiled execution) generated by any of the subsystems and when possible, recovers gracefully
Coordinating asynchronous, parallel processing dependencies between subsystems
Scheduling hatch processes “offline”, meaning the User is not waiting for all processes to complete and is able to work with partial results or is free to leave the system entirely. The User can then he notified when certain processes are complete

As initiator of Third Party Services, the project controller may optionally function as a commercial distributor for the Third Party Services, assessing charges to users and accounting for payments to the respective Service Providers of such third Party Services.

### Video PS Encoder/Decoder

Results of the intensive processes used to augment and manipulate the Project Video generate significant amounts of data which should ideally be packaged and transported as an integral part of the Project Video file. Current encoders accept multiple tracks of audio, video, and text (as subtitles and closed captioning, for instance) and can package them in Streaming Video files. A Streaming Video is packaged in a way that allows play to begin very shortly after the first few data buffers are received, before the entire file has been completely transported. The Video PS Encoder will be able to incorporate and decode the novel, semantic metadata claimed in this invention. Conversion of the Video PS format to other, standard formats will also be available as a hosted Service.

The Video Encoder/Decoder will also have novel parameters designed to maximize operational efficiency as required for practicing all of the functionalities of the disclosed Invention.

### API Wrapper

The Invention's API Wrapper includes the Service API database and processing capability to access Recognition Services. The ability to interface with third party Recognition Services is integral to the invention. The Invention thus takes advantage of third party advances in machine recognition technologies to optimize the speed, quality, and depth of deconstructing or semantics mapping of audiovisual files possible in any Project.

### Pinner/Navigator

The Pinner/Navigator creates the .CXU file(s) for persistence across user sessions and for portability. While the focus of the .CXU file is for the text medium, other media may also be exported to a media-specific .CXU file to support streaming portability of the pinned boundaries by different instance of service execution on a different machine or time. The Pinner/Navigator comprises a textual editor and associated VI enabling the user to modify textual objects in the .CXU File and in turn automatically operate on the video and audio forms of the project file. The Pinner/Navigator can independently identify pin locations based on its own speech-to-text capabilities in conjunction with user interaction with the text and extrapolation techniques. Additionally, the Pinner/Navigator may utilize third party recognition services to generate input to the .CXU file.

### Semantics Calculator

The Semantics Calculator of the Invention comprises a method for applying, correlating, and distilling meaning from audiovisual content based on assimilation of results (or lack of results) from the following sources: (1) Multiple Recognition Services, (2) Users' input via the Semantics Editor, (3) Comics Actuator, (4) Plot Actuator, (5) Natural Language Processing (NLP) techniques, (6) Ontology Matching operations, or (7) Other, possibly domain specific semantic manipulation schemes. The Semantics Calculator operates on Recognized Objects using a Semantic Calculus always in the context of the Objects' Pinned Boundaries. Objects are identified initially by Recognition Services, their beginning and ending boundaries along the time continuum of the media being a defining feature. Along with the boundaries, some sort of meaning is assigned either directly by the originating Recognition Service or inferred by the API Wrapper. As illustration, ‘meanings’ may take the following forms: (1) tags, (2) names, (3) codes, (4) numbers, (5) icons, (6) glyphs, (7) images, (8) classifications, (9) labels, (10) audio narrative, musical notes (scores), (11) text narrative, (12) translations, (13) idioms, (14) music .midi files, or (15) any humanly-recognizable mark, visual or audio (and for Accessibility or Virtual Reality enabled machines, any other media). In addition to original assignments of meaning, the Semantic Calculator may derive meanings for all or part of one or more Objects to create new Objects using its own Semantic Calculus similar in logical construction to Arithmetic operators. Some operations that can be performed by the Semantic Calculus are as follows:
Objects are identified by Recognition Services by their beginning and ending boundaries alone the time continuum of the media,
Names, tags, classifications, and labels assigned by any Recognition Service or User Interface constitute Semantic interpretations of Objects.
Objects may be associated with all or part of one or more other Objects to create new-Objects. The operations that can be performed:
Addition—Recognized Objects with discontinuous boundaries can be combined to create a single Recognized Object. In movie editing terms this would be called splicing. It is used here to refer to semantic calculations on the pinned boundaries, the result of which may indirectly result in a splicing operation at audiovisual output time, or it may only effect a more fine-grained navigation ability, and make Equivalence Assignment a much simpler task for the User,
Subtraction—boundary reassignment to a point already contained in the Object
1 Division—One Object split into two by the insertion of one boundary point serving as the end of one and the beginning of another.
Equivalence Assignment—using the Add, Subtract, Division between two or more Objects or between an Object and a Meaning (tags, names, codes, etc.,), including assigning a NOT, or negative equivalence.
Transitive Inference—External Ontologies matched to the working Ontology and thereby transitively apply new Names to Objects. To illustrate: If ‘Mary’ is named in one Object, and ‘Talking’ is characterized in a different but overlapping (determined by Pin Boundaries) object the Calculator might infer that Mary is talking. In this way, too, external Ontologies are matched to the working Ontology, new Names are thereby transitively applied to Objects.

All Object Names become part, of the working Ontology for the project. The Semantic Calculus operations themselves are immediately reflected in the semantic layers. Because object operations are effected as layers and not modifications, when changes (corrections) or reversals are made to previously specified recognition calculations, the original versions are deprecated but not deleted. This form of version control allows the user to “go back in time” to previous editing versions.

The Invention adopts and promotes the conception that the above named varied types of media can indeed be considered to be “meaning.” Per the Invention, a user plays a role in the recognition process via the Semantics Editor. This UI provides a means to overlay all kinds of media (photos, additional movie clips, music, etc.) that will be related semantically (e.g., per the above operations) to the original media. The treatment of semantic operations by the Invention architecture is independent of the source, whether from a third party, operations of the Invention, or user input.

### Comics Actuator

The Comics Actuator is the apparatus for enabling creation of a comics stylized output based on the source audiovisual file and based on user or default inputs or runtime parameters. Types of inputs per the Comics Actuator User Interface comprise the following:
1) Administrative Users & Project Users through Comics Actuator UI:
   a. Character Style mapping specifications
   b. Background Image (Sets)
   c. Comics Style in pre-defined Templates (adventure hero, children, Sunday paper strips,, etc.) or Custom selected
      i. Word bubble style (shape, placement, fonts, etc.)
      ii. Character abstraction level
      iii. Color palette
      iv. Sequential Frames orientation (left to right then top to bottom)
      v. Page orientation formulas (strip, nine panel, etc.)
      vi. Number of pages (Graphic novel, weekly—12 pages, single page, one frame, single glyph, etc.)
   d. Draft Project Output Edits
2) Recognition Services through the API Wrapper
   a. Frame-to-image transformation into stylized sketches
   b. Object replacements
   c. Speech-to-Text
   d. Language Translator
3) Plot Actuator

### Processing Functions:

1) Semantic Calculator
   a. Automated ranking and sorting potential Candidate Frames to lit Template specifications
   b. Distillation of text for Word Bubbles by applying Semantic Equivalence Reduction to the word count determined by Template definitions

### Output Formatting:

According to the Template definitions

### Plot Actuator

Plot Actuator captures one or more semantic formulae in the form of Semantic Calculus, the language interpretable by the Semantic Calculator. The semantic formulae may be used to perform tire following functions:
Recognize existing plot components in the video by means of semantic equivalence analysis performed by the Semantic Calculator
Match Project Video to Standard Plots (Interpersonal Conflict and Resolution, Love Story, Disaster Film, etc.)
Rate the Project Video on its entertainment merits. Many videos are uninteresting. An interactive checklist of matched plot components may determine that the video could use some additional intrigue.
Additional Components may be added from external sources to augment the video. The resulting, augmented video may thus be more playful or humorous.
‘What-if scenarios’ can be generated, casting the content in the project video in different semantic contexts

### Recognized Objects Data Store

Inputs for the Recognized Objects Data Store are the following:
1) Recognition Services Results via API Wrapper
2) Video PS Semantic Calculator UI for human interpretations
3) Semantic Calculator

The contents or attributes per the Recognized Objects Data Store are the following:
Project identifier
Original recognition results from machine -recognition services:
Source Recognition process
Version of Source (if applicable)
Date of recognition process
Wrapper Notes (example: parameters used to invoke Recognition Service)
Recognized Category in Recognition Source's terms (examples: Person, Animal, Place or Thing, Round Object, Tree, Insect, etc.).
Recognized Type within Category (example: Dog (within Animal category), Poodle (within a Dog category)
Probability values for Category and/or Subtypes
Timing offset within media
Unlimited number of Equivalence relationships

### Semantics Editor

The Semantics Editor provides a User Interface providing user access to the results of all derived metadata and semantic inferences in context of the original media. Additional recognition information is automatically captured as the User isolates, notates, or modifies the various clips and recognized semantics via the UI of the Semantics Editor. The UI may provide for open crowd sourcing, collaboration-enablement, or single user input. To support collaboration the interface will be compatible with fine-grain security control and advances in federated security protocols.

With the proper security, the user can also insert new media as a semantic layer. The new media would be incorporated into the video project using any of the semantic calculus operators. From an internal architecture perspective, the inserted object is treated the same as a result from any recognition service. In this case, the user serves as the recognition service.

### About Recognition Services

The term Recognition Service as used herein refers broadly to any machine process, primarily from third parties, which accepts some form of media as input and returns machine-readable identification information about one or more features of the medium. Recognition Services may have different schemes of identification and categorization and can potentially operate on any medium available today or in the future.

Machine recognition and machine learning are areas of intense research and development. There are many existing methods and services available today and the type and quality available of these services will grow dramatically for the foreseeable future. This invention provides an execution infrastructure as disclosed to access any number of both third party and novel Recognition Services then normalize, assemble, and reconcile the multiple recognition results from these Recognition Services.

The choice of Recognition Service to be used for any given Video Project, and the order of application of the Recognition Service (including simultaneous, asynchronous execution), accessed during an editing session, will be determined at execution time and may be based on one or more of the following:
User-set priorities
Cost to access the Recognition Services
Time required to access the Services
Applicability of the Service(s) to the Project task; at hand

The type of medium processed and the particular format for that medium can be anything available now or in the future including but not limited to the following:
sound as file type.mp3, .wav
video as file type.avi, .mts, .mp4, etc.,
images as file type jpg, .png, etc.,
text as file type .doc, .txt, .srt, .sls, DFXP, etc.
ontology as file type RDF, OWL, DAML, etc.

During a mapping or deconstruction of a video prior to editing, some possible types of recognition, each captured in the Recognized Objects Data Store along with the incidence time offset location, are the following: (1) Motion Analysis using either video or frame series, (2) Unique Object visual recognition or figure isolation, (3) Unique Person visual recognition, (4) Scene/Background Detection, (5) Unique Voice audio recognition & separation, (6) Ambient, noise audio recognition & separation, (7) Speech to Text, and (8) Sentiment Analysis on audio voice or visuals—facial expression or body language

### BRIEF DESCRIPTION OF THE DRAWINGS

FIG. 1 is a block diagram of a system for generating n-dimensional semantic layers per the preferred embodiment of the Invention.

FIG. 2 is a block diagram of steps to practice the disclosed invention.

### DETAILED DESCRIPTION OF THE DRAWINGS

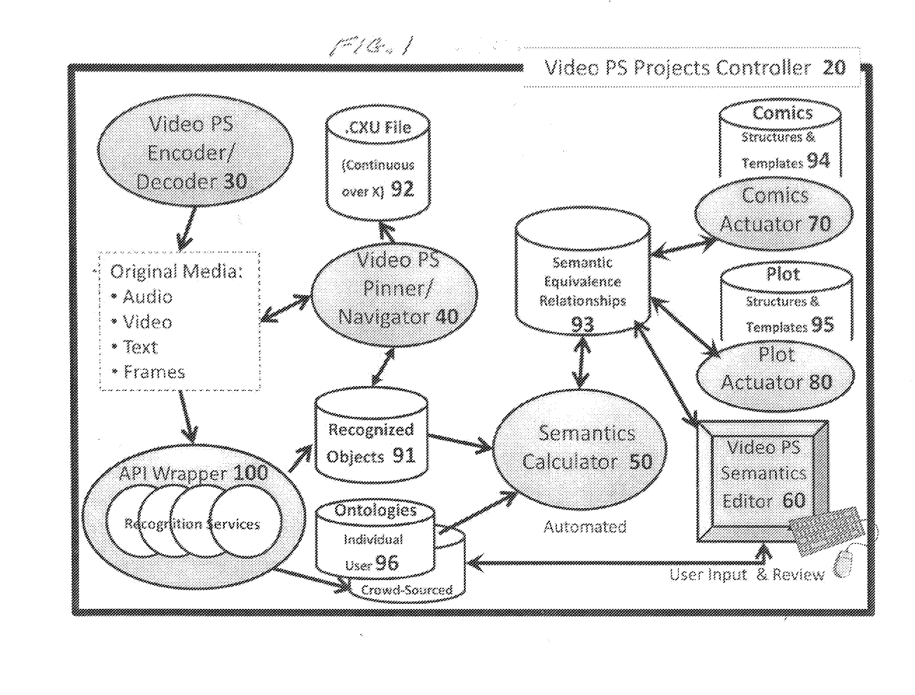

FIG. 1 is a block diagram showing components of the web-based system for generating n-dimensional semantic layers per a preferred embodiment of the Invention. As more fully described above shown are the projects controller 20 which manages the machine operations required to practice the Invention, a semantics editor 60 accessed by the user computer via its web browser, the semantics editor providing user access to semantic equivalence relationships 93 generated via user input, a comics actuator 70, a plot actuator 80, and a semantics calculator 50, the semantics calculator 50 operating on recognition services results stored in a recognized objects data store 91, a .CXU file data store 92, and an ontologies data store (individual user 96, also may be crowdsourced), .CXU files created by the pinner/navigator 40, project files encoded via the encoder/decoder 30, users accessing the pinner/navigator 40 via a UI (not shown).

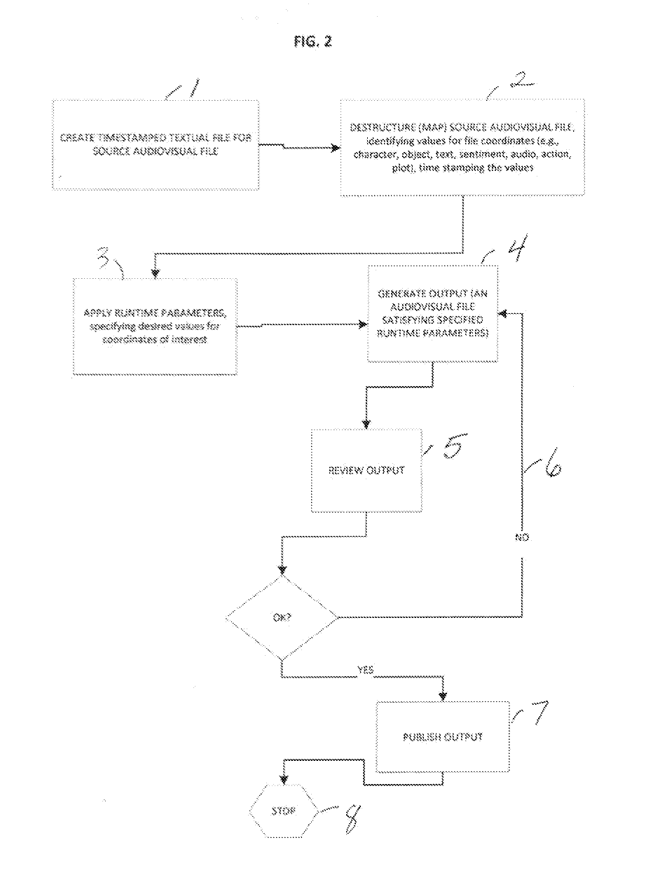

FIG. 2 is a block diagram describing the computer-implemented steps for practicing the Invention. Thus at Step 1, a time stamped textual file is created for the source audiovisual file to be worked on in the Project. At Step 2, the source audiovisual file is automatically mapped or deconstructed via an automated (and including optionally user-aided) recognition process. The mapping incorporates n-dimensional semantics mapping. At Step 3, runtime parameters, either default or user-input, for the desired output are specified for the given video project editing session. The system then automatically generates an output satisfying the specified runtime parameters. At Step 4, the user is presented with a graphical user interface enabling a review of the machine-generated output. The user may modify the outputted video or modify runtime parameters to generate a new video. At Step 6, the user may choose to publish the outputted video. Publishing of the edited video may be automatically directed to a social network platform site such as Twitter, LinkedIn or Facebook or similar.

I claim:

1. A web-based system for providing a service for on demand editing, navigation, and augmenting of audiovisual files comprising one or more user computers configured with a web browser and one or more service servers, users accessing the service servers via the web browser over the Internet, the service servers comprising one or more subsystems, each subsystem comprising machine executable code embodied on a non-transitory computer-readable medium enabling functionalities as defined:
a pinner/navigator which automatically creates a .CXU file of an audiovisual project file uploaded to the service, the .CXU file capturing incidence time offsets for textual objects in the file, the pinner/navigator comprising an editor providing a graphical user interface enabling users to edit the audiovisual project file by modifying textual objects, pinning beginning and ending boundaries for textual objects of interest, and navigating the file by selecting textual objects, the pinner/navigator automatically outputting an edited project file per users' edits;
a service API wrapper providing an interface for accessing one or more recognition services which automatically generate semantic metadata for the user-uploaded audiovisual project file, the semantic metadata comprising recognized objects and their semantic interpretations, the recognized objects being associated with their respective incidence time offset relative to the start time zero of the source audiovisual file of the project file, recognized object names becoming a part of a working ontology for the project file;
a semantic Calculator operating on recognized objects using a semantic calculus in one or more operations from the group of addition, subtraction, division, equivalence, and transitive inference wherein an external ontology is matched to the working ontology to transitively apply new names to recognized object names,
a semantics editor providing a graphical user interface allowing users to access recognized objects, input additional recognition, recognized objects stored in a recognized objects data store comprising project identifiers, recognition specifics,
an audiovisual file encoder/decoder which incorporates and decodes the semantic metadata generated for the uploaded source audiovisual project file,
and a project controller comprising a cloud-enabled multi-processor asynchronous processing for managing operations comprising user security and initiating service operations as required to accomplish user requests.

2. The system per claim 1 wherein the .CXU file created by the pinner/navigator comprises a format wherein an ASCII space character between a first textual object and an immediately following textual object is replaced with a binary number representing the number of seconds of incidence time offset between the first textual object and the immediately following textual object.

3. The system per claim 1 wherein the service servers further comprise a plot actuator comprising a semantic formula for recognizing plot components in the project file by means of a semantic equivalence analysis performed by a semantic Calculator, the plot actuator configured to automatically match the project file to one or more pre-defined standard plots per a plot structures and templates data store and to rate the project file on its entertainment merits, the plot actuator comprising a graphical user interface allowing the user to incorporate new content into the project file from a source external to the project file.

4. The system per claim 1 wherein the service servers further comprise a plot actuator and a comics actuator, the plot actuator comprising a semantic formula for recognizing plot components in the project file by means of a semantic equivalence analysis performed by the semantic calculator, the plot actuator configured to automatically match the project file to one or more pre-defined standard plots per the plot structures and templates data store and to rate the project file on its entertainment merits, the plot actuator comprising a graphical user interface displaying the matching information and the rating of entertainment merit and allowing the user to incorporate new content into the project file from a source external to the project file, the comics actuator comprising image processing for transforming project file video frames into stylized images, the stylized images incorporating an automatically generated word bubble comprising a summarization of textual objects associated with the project file video frames by applying a semantic equivalence reduction to a word count as determined by pre-defined comics structures and templates, a graphic user interface enabling a user to (a) select an output style from pre-defined templates per the Comics Structures and Templates data store and (b) specify character style mapping and background image, and (c) edit the word bubble.

5. The system per claim 1 wherein the recognition, metadata comprise an object recognition category, a recognized type within the recognition category, and a probability value for the recognition category and the recognized type.

6. The system per claim 1 wherein the recognition services access and integrate one or more items in the group of motion analysis, unique object visual recognition, unique person visual recognition, speech-to-text, sentiment analysis, background detection, ambient noise audio recognition and separation, and unique voice audio recognition and separation.

7. The system per claim 1 wherein the semantics editor is accessible to a single user, multiple users as in a crowdsourcing environment, or two or more users in a team collaboration environment.

8. A computer-implemented process for user on demand editing, navigating and augmenting of a source audiovisual file, the process embodied in executable software embodied on a non-transitory computer-readable medium for carrying out the process steps, the process steps comprising
Providing a .CXU file that is a time stamped textual transcript of the source file, the file comprising textual objects associated with their incidence time offset in the source file;
Via a graphical user interface enabling a user to perform an editing operation on the .CXU file via a pinning process comprising one or more iterations wherein the user selects a portion of the .CXU file as a beginning boundary and a portion as an ending boundary, and where the editing operation is one or more items from the group comprising delete, move, replace, export, and modify text, the graphical user interface also enabling the user to navigate the source file by selecting portions of text in the .CXU file, and
Automatically generating an edited version of the source file based on the editing operation.

9. The process per claim 8 wherein the step of providing a .CXU file comprises accessing a third party recognition service that comprises a speech-to-text recognition software.

10. The process per claim 8 further comprising the step of automatically publishing the edited version of the source file.

11. The process per claim 8 further comprising the steps of
Automatically mapping the source audiovisual file via a semantic distillation process performed by recognition services, the mapping generating recognized objects results, the recognized objects associated with their respective incidence time offsets per the source file,
Providing a graphical user interface enabling the user to modify the recognized objects results,
Providing a graphical met interface enabling the user to set editing session runtime parameters by designating values for one or more recognized objects of interest, and
Automatically generating an edited version of the source file based on the selected runtime parameters.

12. A computer-implemented process for user on demand editing and augmenting of a source audiovisual file, the process embodied in executable software embodied on a non-transitory computer-readable medium for carrying out the process steps, the process steps comprising
Providing a source audiovisual file comprising visual, audio and text components,
Automatically mapping the source audiovisual file via a semantic distillation process performed by recognition services, the mapping generating one or more recognized objects, the recognized objects associated with their respective incidence time offsets per the source file,
Providing a graphical user interface enabling the user to specify one or more editing session runtime parameters from the group comprising number of frames, duration for the edited version of the audiovisual file, a stylization value for the frames, specific value for a recognized object, a degree of semantic distillation
Based on the selected runtime parameters and optional stylization value, automatically generating an output from the group comprising an edited audiovisual file, one or more still images and a glyph;

13. The process per claim 12 wherein the stylization value is a Sunday comics strip.

14. The process per claim 12 further comprising the step of
Providing a graphical user interface enabling a user to insert new media into the project file during an editing session, the new media being incorporated as a new semantic layer with the user acting as a recognition service.
